(19) United States
(12) Patent Application Publication
(10) Pub. No.: US 2014/0054063 A1
(43) Pub. Date: Feb. 27, 2014

(54) METHOD OF MANUFACTURING A COMPOSITE INSULATOR USING A RESIN WITH HIGH THERMAL PERFORMANCE

(71) Applicants: Jean Marie George, Vichy (FR); Guy Thevenet, Beaumont Les Randan (FR); Sandrine Prat, Mariol (FR)

(72) Inventors: Jean Marie George, Vichy (FR); Guy Thevenet, Beaumont Les Randan (FR); Sandrine Prat, Mariol (FR)

(73) Assignee: SEDIVER SOCIETE EUROPEENNE D'ISOLATEURS EN VERRE ET COMPOSITE, Nanterre Cedex (FR)

(21) Appl. No.: 14/110,584

(22) PCT Filed: Apr. 19, 2011
(86) PCT No.: PCT/FR2011/050893

§ 371 Date: Nov. 8, 2013

(51) Int. Cl. H01B 19/04; H01B 3/40

(52) U.S. Cl. CPC H01B 19/04; H01B 3/40
USPC 174/137 B; 264/259

(57) ABSTRACT

The method of fabricating a very high, high, or medium voltage composite insulator (1) comprises an insulating core (2) made of glass fiber reinforced synthetic material based on a mixture of a resin having epoxy groups, and a covering (3) made of an elastomer material surrounding said core (2), said elastomer material being selected from silicone, ethylene propylene diene monomer (EPDM) and mixtures thereof, and vulcanizing at a vulcanization temperature higher than 130° C.

### TECHNICAL FIELD

The invention relates to the field of very high, high, or medium voltage composite insulators, comprising an insulating core made of glass-fiber-reinforced synthetic material based on a mixture of a resin and of a hardener, and a covering made of high-temperature vulcanizing elastomer material and surrounding said core.

### PRIOR ART

The invention applies more particularly to the field of composite electrical insulators for very high, high, or medium voltage. When such composite insulators are for providing electrical insulation between an electricity line and ground or between phases of electricity lines, in particular in the fields of transporting energy or of electrifying railway lines, they preferably have a solid core of the rod type. Other composite insulators for providing electrical insulation in the design of large pieces of equipment, e.g. of the type comprising transformer terminals, circuit breakers, cable terminations, etc., are preferably made with a hollow core of the tube type.

Such composite insulators are generally made up of an elongate insulating core that provides the mechanical function of the insulator in traction, in bending, in twisting, and in compression, and that is surrounded by a covering of elastomer material that guarantees protection of the insulator against erosion and that provides a creepage line that is appropriate for avoiding an external arc when conditions are wet or involve ambient pollution. Each of the ends of the insulating core is fastened in or on a standardized metal end fitting for putting the insulator into place either on an electricity line or on the equipment under consideration.

Such a composite insulator is generally formed from a stratified synthetic material that is made by using glass fibers impregnated with a resin and by shaping, e.g. by winding the impregnated glass fibers on a support, in particular for a hollow tube insulator, or by pultrusion of impregnated glass fibers, in particular for a solid rod insulator.

The elastomer covering of such a composite insulator is in the form of a sheath covering the core over its entire length and having radial fins arranged thereon that are spaced apart along the sheath. Conventionally, the elastomer covering may be made using various methods, for example an extrusion method, a compression molding method, or an injection molding method using elastomer material, the covering then always being heated in order to vulcanize the elastomer material of the covering. The covering may be formed directly on the insulating core or it may be formed separately before or after the end fittings have been fastened to the insulating core.

The elastomer material of the covering is generally based on ethylene propylene diene monomer (EPDM) or on silicone or indeed on a mixture of EPDM and silicone. It is often preferred to use a high-temperature vulcanizing elastomer, i.e. an elastomer that vulcanizes at a temperature higher than 100° C., or indeed higher than 130° C. In order to form and vulcanize a covering based on such an elastomer by molding or by extrusion it is necessary to reach temperatures that are generally higher than 130° C., or indeed higher than 160° C. For example, so-called “high-temperature vulcanizing” (HTV) silicone may be selected because it provides the insulator with very good resistance to erosion under electrical activity and arcing on its surface. Nevertheless, high-temperature vulcanization of such an elastomer on the core is associated with numerous drawbacks.

The vulcanization temperatures of the elastomer reached during vulcanization of the covering on the core are generally high enough to exceed the glass transition temperature (T_{G}) of the resin-and-hardener mixtures used for forming the insulating core, where the glass transition temperature characterizes the transition from a rigid glassy state to a flexible viscoelastic state. The insulating core can therefore soften and deform, thereby harming the general quality of the insulator.

In particular, for an insulator having a tube type hollow insulating core, the tube may become degraded by delamination, it may deform, and it may even collapse.

For an insulator having a rigid type solid insulating core, also known as a rod insulator, when the covering is formed by molding on the rod, the rod can soften and thus lead to a risk of the rod being damaged on being removed from the mold.

Furthermore, when the end fittings are fastened to the core before forming the covering on the core (regardless of whether the core is in the form of a rod or of a tube), the strength of the fastening between the metal end fittings and the core can be compromised by softening of the core. By way of example, softening of the core may lead to mechanical weakening of the fastening of the metal end fittings on the core weakening by relaxation.

In order to mitigate that drawback, it is possible to fasten metal end fittings on the core in two stages, namely a first fastening stage, e.g. by crimping the end fittings on the core before forming the covering on the core, followed by a second fastening stage, e.g. by crimping end fittings on the core after the covering has been formed on the core. Nevertheless, that leads to an additional risk of cracking because of the stresses already exerted by the first fastening stage.

It is also possible to fasten the end fittings on the rod after forming the covering on the rod, but under such circumstances the sealing of the composite insulator, which is usually performed merely by bonding the elastomer material onto the end fittings while forming the covering on the rod, no longer takes place. It is then necessary to add one or more sealing gaskets in association with the metal end fittings, and gaskets are a known weak point in a composite insulator because of the risk of a gasket failing or because of the short lifetime of a gasket compared with the length of time a composite insulator is used.

In order to mitigate those drawbacks, attempts have already been made to introduce a mandrel inside the tube, while the silicone covering is being formed by injection molding on the tube, so as to prevent degradation or collapse of the tube. Nevertheless, the considerable weight of the mandrel involves a handling stage that is difficult, and the use of a mandrel represents an additional step that is expensive in the fabrication of the insulator.

### SUMMARY OF THE INVENTION

The object of the invention is to remedy all of those drawbacks by proposing another method of fabricating a composite insulator having an insulating core of synthetic material surrounded by a covering of high-temperature vulcanizing elastomer material, the insulator presenting improved high-temperature strength of the core.

To this end, the invention provides a method of fabricating a very high, high, or medium voltage composite insulator comprising an insulating core made of glass fiber reinforced synthetic material based on a mixture of resin and a hardener, and a covering made of high-temperature vulcanizing elastomer material and surrounding said core, the method being characterized in that it comprises at least the steps consisting in:
selecting a mixture composition in such a manner as to obtain a glass transition temperature for said synthetic material that is higher than the vulcanization temperature of said elastomer material; and
vulcanizing at said covering of elastomer material on said core of synthetic material.

With the method of the invention for fabricating a composite insulator, a composite insulator is obtained, whether it has a hollow core of the tube type or a solid core of the rod type, that associates excellent high-temperature strength for the insulating core, i.e. very good high temperature stability while conserving very good mechanical properties, with excellent protection, in particular against erosion, as provided by the covering made of high-temperature vulcanizing elastomer.

In particular, the method invention makes it possible to vulcanize the covering on the core at high temperature, i.e. at least 130° C., or indeed at least 170° C., without any risk of damaging the core.

For example, when forming and vulcanizing the covering on the core by molding, the method of the invention makes it possible to form a core that withstands the temperature and the pressure to which it is subjected during the molding and that therefore retains its shape and its characteristics at the end of molding.

Furthermore, with an insulator of the invention having a rod type solid core, the mechanical characteristics of the resin forming the rod are not affected by the envelope being formed on the rod, thus making it easier to crimp end fittings on the rod.

With a tube type hollow core insulator of the invention, degradation and collapse of the tube during or after the forming of the covering on the tube are avoided in a manner that is simple and effective. Furthermore, there is no need to use a mandrel that is heavy and difficult to handle.

The method of the invention for fabricating a composite insulator may advantageously present the following features:
the envelope is molded around the core;
the method further includes a step consisting in fastening metal end fittings to the ends of said core and in molding the covering around the core and the end fittings. Advantageously, with the method of the invention, the mechanical characteristics of the core are conserved without any risk of relaxation after the covering has been formed, since softening of the core takes place at temperatures higher than the temperature at which the covering is formed. It is thus possible to fasten the end fittings before forming the covering on the core and the composite insulator is sealed merely by the covering bonding onto the metal end fittings, and thus without requiring any additional gasket;
the covering is formed by an injection molding method, or by a compression molding method, or indeed by an extrusion method;
said resin is selected from resins based on epoxy groups and said hardener is selected from hardeners of the nadic ethyl anhydride type. Advantageously, the hardener of the nadic ethyl anhydride type present in the synthetic material of the core of the composite insulator of the invention provides the advantage of presenting a main chain that is rigid, and as a result makes it possible to raise the glass transition temperature T_{G} of the synthetic material of the core;
in order to obtain said synthetic material, a mixture is made in which the weight of the hardener lies in the range 85% to 95%, preferably in the range 89% to 91%, of the weight of said resin;
a hardener is selected that presents characteristics such that after said hardener and said resin have been mixed together, said glass transition temperature of said synthetic material lies in the range 130° C. to 200° C., and preferably in the range 170° C. to 190° C.;
in order to form said covering, the elastomer material used is silicone, ethylene propylene diene monomer, or a mixture based on silicone and on ethylene propylene diene monomer; and
in order to reinforce said synthetic material, glass fibers are used having a diameter lying in the range 10 micrometers (μm) to 40 μm.

The invention also provides a composite insulator obtained by such a fabrication method and characterized in that it has a tube type hollow core or a rod type solid core.

### BRIEF DESCRIPTION OF THE DRAWINGS

The present invention can be better understood and other advantages appear on reading the following detailed description of embodiments given as non-limiting examples and shown in the accompanying drawings.

FIG. 1 is a fragmentary section of a composite insulator of the invention, based on a rod.

FIG. 2 is a graph showing the results of tests for determining the glass transition temperature of a resin composition.

FIG. 3 is a fragmentary section view of another composite insulator of the invention, based on a tube.

FIG. 4 is a flowchart showing the steps of the method of the invention for fabricating a composite insulator.

### DESCRIPTION OF EMBODIMENTS

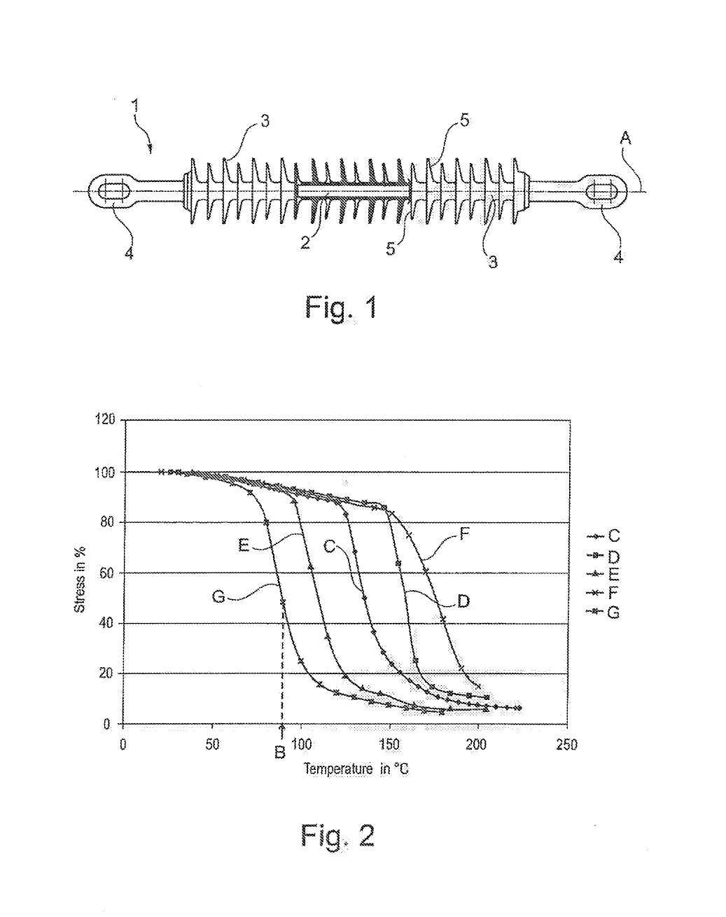

FIG. 1 shows a composite electric insulator 1 for very high, high, or medium voltage that comprises a solid core 2 of the elongate rod type that extends along a longitudinal direction A, a covering 3 surrounding the core 2 and forming a radial ribs in the form of successive flared disks 5 that extend substantially perpendicularly to the direction A of the core 2, and metal end fittings 4 fastened to the respective ends of the core 2.

The covering 3 is made of elastomer material that vulcanized is at high temperature, preferably of HTV silicone, that vulcanizes at a temperature higher than about 130° C.

A suitable synthetic material composition for the core 2 that is in accordance with the invention should be thermally stable up to a temperature of at least 130° C., preferably higher than 150° C., preferably lying in the range 170° C. to 190° C., and possibly extending to as high as 220° C., i.e. the glass transition temperature of the synthetic material lies in the range 130° C. to 220° C., and preferably in the range 170° C. to 190° C.

Advantageously, the core 2 is made of a stratified synthetic material reinforced with glass fibers and made from a mixture of a resin based on epoxy groups, a hardener, and an accelerator. Naturally, other ingredients may be added to the synthetic material depending on particular requirements. Preferably, the glass fibers have a diameter lying in the range 10 μm to 40 μm.

For each resin, the hardware is advantageously selected from hardeners that present characteristics such that after the resin and the hardener have been mixed together, the glass transition temperature T_{G} of the synthetic material forming the core 2 is higher than the vulcanization temperature of the elastomer material forming the covering 3.

More precisely, such a hardener is preferably identified on the basis of a mechanical test serving to determine the softening temperature of a synthetic material under test, it being understood that the softening temperature is equal to the glass transition temperature T_{G} of the synthetic material.

FIG. 2 shows curves giving the results of mechanical tests serving to determine the respective glass transition temperature is T_{G} of various synthetic materials respectively labeled by references C, D, E, F, and G. More precisely, variations in applied twisting stress are plotted as a percentage (%) as a function of temperature in degrees Celsius (° C.).

Such a mechanical test consists in measuring the variation in the opposing torque that is associated in known manner with the applied twisting stress as measured on a test piece of synthetic material when the test piece is subjected to a twisting force as a function of temperature. When the test piece reaches its softening temperature, i.e. its glass transition temperature T_{G}, the opposing torque collapses, as shown for example in FIG. 2 by arrow B pointing to the curve G.

Thus, the curves C, D, and F serve to determine respective glass transition temperatures T_{G} of about 140° C., 160° C., and 180° C. that are higher than the vulcanization temperature of the elastomer material (130° C. in this example), which materials thus correspond to the synthetic materials in accordance with the characteristics of the invention. In particular, the curve C shows an example of a synthetic material in accordance with the characteristics of the invention but that does not possess optimum quality, since the glass transition temperature T_{G} of this material is low. In contrast, curves E and G, which reveal glass transition temperatures T_{G} respectively of about 110° C. and 90° C., i.e. temperatures lower than the vulcanization temperature of the above described elastomer material, correspond to synthetic materials of the prior art.

In preferred manner, the collapse of the opposing torque in twisting takes place suddenly and quickly, indicating a synthetic material that is very stable as a function of temperature up to its glass transition temperature T_{G} at which it softens suddenly, as can be seen for example with the synthetic material of curve G.

In a variant, the collapse of the opposing torque in twisting may also occur after a progressive drop in the opposing torque, which may be prolonged as applies for example to curve D, without thereby going beyond the ambit of the invention. Such a progressive drop in the opposing torque merely indicates a synthetic material that softens a little progressively up to its glass transition temperature T_{G} at which it softens completely and suddenly. This behavior may be due to synthetic materials of poorer quality or that are poorly identified, but it nevertheless remains possible without ambiguity to determine the glass transition temperature T_{G} of the synthetic material under consideration.

In order to perform such a test, it is appropriate to cut out a plate of the synthetic material for testing to a determined size in order to obtain a test piece, in general and in conventional manner a rectangular plate having a thickness of a few millimeters, e.g. lying in the range 1 millimeters (mm) to 3 mm, a width of about one centimeter (e.g. lying in the range 0.5 (centimeters) cm to 2 cm), and a length of a few centimeters (e.g. lying in the range 4 cm to 10 cm), and to subject the resulting test piece to twisting forces, after taking care to hold the ends of the test piece firmly in appropriate jaws. Thereafter, the temperature of the test piece is raised progressively while monitoring the value of the applied twisting torque.

It should be understood that the same consequences apply likewise to applications in traction, in bending, in twisting, or in compression.

In a preferred embodiment of the invention, the hardener is of the nadic methyl anhydride type, and is preferably methyl endo methylene tetrahydrophthalic (METH) anhydride of formula I:

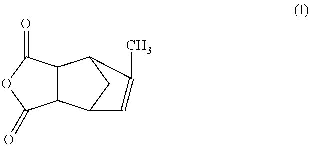

This formula I comprises a chain that is strongly stiffened by the presence of a methyl group on an aromatic ring thus making it possible to obtain a so-called “high T_{G}” hardener, thereby conferring on the synthetic material of the core 2 a glass transition temperature T_{G} that is high.

Without departing from the ambit of the invention, it is also possible to select some other hardener from the family of nadic methyl anhydrides, preferably including molecules with a single aromatic ring and few or no secondary groups, and/or secondary group chain lengths that are short, these characteristics making it possible to further stiffen the main chain of the hardener and thus achieve a glass transition temperature T_{G} for the synthetic material that is high.

An accelerator should be selected from the accelerators that are conventionally used for accelerating the setting of epoxy resins.

In order to obtain the glass transition temperature T_{G} that is desired for the synthetic material of the core 2 of the invention, the resin based on epoxy groups and the hardener are mixed together in the following precise proportions: one epoxy equivalent for one anhydride equivalent, which corresponds to the hardener having weight that represents 85% to 95%, and preferably 89% to 91% of the weight of the resin. The proportions of resin and of hardener should be controlled carefully since any non-consumed hardener that is present in the composite insulator 1 might react with ambient moisture and form acids capable of attacking the glass fibers of the core 2, thereby greatly weakening the mechanical strength of the composite insulator 1.

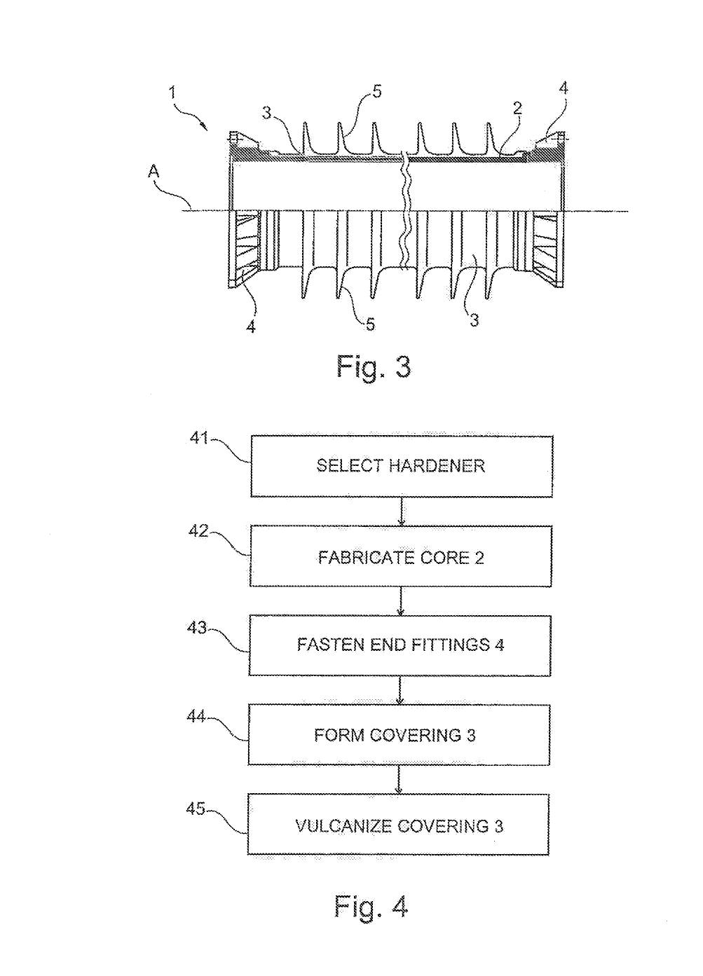

FIG. 3 shows another very high, high, or medium voltage electrical composite insulator 1 comprising a hollow core 2 of the tube type. In FIG. 3, the same numerical references correspond to the same elements as those having the same references in FIG. 1.

There follows a description of examples of fabricating a composite insulator 1 of the invention, given with reference to FIG. 4.

The method begins with a step 41 of selecting a hardener-and-resin mixture as defined above for fabricating the core 2, which mixture therefore presents characteristics such that after the hardener and the resin have been mixed together in order to obtain the synthetic material, the glass transition temperature of the resulting synthetic material is higher than the vulcanization temperature of the elastomer material forming the covering 3.

Thereafter, in a step 42, the core 2 is fabricated from a glass fiber reinforced synthetic material that is formed as described above from a mixture of epoxy resin, of hardener as defined above, and of an accelerator, while complying with the above-specified hardener-and-resin proportions.

By way of example, the core 2 may be fabricated by pultrusion of the glass fiber reinforced synthetic material when the core 2 is of the solid rod type, or by winding a filament around a mandrel when the core 2 is of the hollow tube type.

Thereafter the synthetic material is caused to harden and cure by heating the core 2. The hardening and curing step may include one or more temperature pauses of values and of durations that may vary as a function of the size of the core 2 that is to be hardened and/or of its particular shapes. For example, it can be understood that a solid core 2 of rod type presenting a large diameter will take longer to cure than a solid core 2 of rod type, but having a smaller diameter. Furthermore, a hollow core 2 of the tube type will require longer hardening times, given the areas in contact with the outside and the thicknesses under consideration.

Finally, care should be taken to ensure that the core 2 is not subjected to temperature thresholds that are too sudden, since otherwise there is a danger of curing becoming excessively exothermic and causing the synthetic material to crack.

The core 2 obtained after a hardening and curing can then be cut to length according to requirements.

In a particular implementation of the method of the invention, the rod-type solid core 2 may be fabricated by pultrusion. Under such circumstances, the glass fibers are initially entrained through an impregnation bath of synthetic material raised to a temperature lying in the range 40° C. to 50° C., so that the fibers become coated in synthetic material. Thereafter, the synthetic-material-impregnated fibers are entrained through a die in order to obtain a solid core 2 having a final diameter that generally lies in the range 14 mm to 120 mm. Finally, the core 2 is passed through a stove or one or more stoves in succession at different temperatures in order to harden and cure the synthetic material forming the core 2. It can be understood that the fibers are entrained through the die at the end of a fabrication line and on a continuous basis using a conventional pultrusion method. The speed at which the fibers are entrained is advantageously adjustable in order to adjust the time taken by the core 2 to pass through the stove(s) and thus adjust the duration of the hardening.

In another particular implementation of the method of the invention, the tube type hollow core 2 is fabricated by winding a filament. Under such circumstances, the glass fibers are likewise entrained through an impregnation bath of synthetic material raised to a temperature lying in the range 40° C. and 50° C. so as to coat them in plastics material. Thereafter, the synthetic-material-impregnated fibers are wound around a rotating mandrel in order to obtain a hollow core 2 having a final diameter that generally lies in the range 80 mm to 1500 mm.

Thereafter, in a preferred implementation of the method of the invention, in step 43, the end fittings 4 are fastened to the respective ends of the core 2, e.g. by applying adhesive to the core 2, or preferably by crimping onto the core 2.

Provision may also be made to fasten the end fittings 4 onto the core 2 after the covering 3 has been formed on the core 2. Under such circumstances, a sealing gasket (not shown) may be provided that is appropriate for providing the composite insulator 1 with sealing at the end fittings 4.

Finally, the covering 3 is formed in step 44 from an elastomer material of the kind described above, and it is then vulcanized in step 45.

In a preferred implementation of the method invention, the covering 3 is formed directly on the core 2 and on the end fittings 4 previously fastened in step 43, thus making it possible to obtain very good sealing of the covering 3 over the entire length of the composite insulator 1, and thus achieving very good protection of the composite insulator 1 against erosion.

In a preferred implementation of a method of the invention, the covering 3 is formed and vulcanized by molding elastomer material directly onto the core 2, such that forming step 44 and the vulcanizing step 45 are performed simultaneously. During the steps of 44 and 45 of forming and vulcanizing the covering 3 by molding onto the core 2, the core 2 remains at a temperature lower than the glass transition temperature of the synthetic material forming the core 2. Thus, by means of the method of the invention, the synthetic material of the core 2 does not reach its glass transition temperature and the core 2 therefore conserves its mechanical characteristics, and in particular its stiffness and its shape, thereby avoiding deformation of the core 2, in particular during unmolding of the composite insulator 1 at the end of fabrication.

In a more preferred implementation of a method of the invention, the covering 3 is made by injection molding onto the core 2, with the end fittings 4 previously being fastened to the core 2. For this purpose, the core 2 together with the end fittings 4 is initially pre-heated, prior to placing the pre-heated core 2 together with the end fittings 4 in an injection mold into which the raw elastomer material is injected in liquid form until the mold is completely filled. The molding and the vulcanization of the elastomer material of the covering 3 are then performed at a temperature lower than the glass transition temperature of the synthetic material forming the core 2.

It can be understood that the duration and the temperature of the injection molding may vary as a function of the elastomer material selected for fabricating the covering 3. By way of example, the preheating may be performed to a temperature lying in the range 80° C. to 100° C. for a duration lying in the range 50 minutes (min) to 70 min, and the molding may be performed at a temperature lying in the range 160° C. to 180° C. for a duration lying in the range 10 min to 20 min.

In another implementation of a method of the invention, the covering 3 is made by compression molding on the core 2. By way of example, a predetermined quantity of raw elastomer material in solid form may be arranged in a mold together with the core 2, prior to performing molding and vulcanization of the covering 3. The molding and the vulcanization of the elastomer material forming the covering 3 are then also performed at a temperature lower than the glass transition temperature of the synthetic material forming the core 2.

In yet another implementation of the method of the invention, the covering 3 is formed initially in step 44 separately from the core 2, and is subsequently vulcanized in step 45 on the core 2. By way of example, it is possible to begin by forming a covering 3 of elastomer form in the form of a smooth sheet, i.e. without the fins 5, and then by engaging the smooth covering 3 as formed in this way on the core 2.

Thereafter, the fins 5, likewise made from an elastomer material of the kind described above, are threaded onto the smooth covering 3. The elastomer material of the covering 3 and of the fins 5 is then vulcanized, e.g. in an autoclave, thus also serving to fuse the fins 5 onto the covering 3. In a variant, it is also possible to begin by vulcanizing separately the elastomer material of the covering 3 and of the fins 5, and then to bond the fins 5 adhesively on the smooth covering 3. Under all circumstances, during vulcanization, the core 2 advantageously remains at a temperature lower than the glass transition temperature of the synthetic material forming the core 2.

Advantageously, the method of the invention unites three conditions in order to obtain a glass transition temperature T_{G} for the synthetic material that forms the core 2 that is greater than the vulcanization temperature of the silicone forming the envelope 3, namely:
arranging in the synthetic material or a composition comprising a mixture of a resin and a hardener having a high glass transition temperature T_{G};
ensuring very accurate measurement of the resin and of the hardener in the synthetic materials; and
having a high degree of curing in the synthetic material resulting from the step of hardening the synthetic material.

Naturally, the present invention is not limited to the above description of a particular implementation that may be subjected to various modifications without thereby going beyond the ambit of the invention.

For example, the covering 3 may be made of some other high-temperature vulcanizing polymer such as ethylene-propylene-diene monomer (EPDM) for example, or a mixture based on silicone and EPDM.

### EXAMPLE

A composite insulator 1 of the invention was made using the following protocol:
making a formulation for the synthetic material of the rod comprising an epoxy resin and a methyl endo methylene tetrahydrophthalic (METH) anhydride type hardener at a ratio of 1:0.9, together with an accelerator;
forming a solid rod 2 by pultrusion in accordance with step 42 of FIG. 4;
hardening the rod in a first cycle of one hour at a temperature of 80° C., followed by a second cycle of one hour at a temperature of 100° C., followed by a third and last cycle of one hour at a temperature of 250° C.;
fastening metal end fittings 4 on the rod 2 obtained in accordance with step 43 of FIG. 4; and
injection molding the covering 3 of HTV silicone onto the rod 2 and vulcanizing the HTV silicone in accordance with steps 44 and 45 of FIG. 4.

A solid-rod composite insulator 1 was obtained with synthetic material having a glass transition temperature T_{G} of about 195° C.

1. A method of fabricating a very high, high, or medium voltage composite insulator comprising an insulating core made of glass-fiber-reinforced synthetic material based on epoxy groups, and a covering made of elastomer material and surrounding said core, said elastomer material being selected from silicones, ethylene propylene diene monomer (EPDM), and mixtures thereof, and vulcanizing at a vulcanization temperature that is greater than 130° C., the method being characterized in that it comprises at least the steps consisting in:
selecting a mixture composition for the core further comprising a hardener selected from methyl endo methylene tetrahydrophthalic (METH) and methyl nadic anhydride (MNA) in such a manner as to obtain a glass transition temperature for said synthetic material that is higher than the vulcanization temperature of said elastomer material;
mixing said resin and said hardener in order to form said synthetic material of the core, with a proportion in weight of hardener lying in the range 85% to 95%, preferably in the range 89% to 91%, relative to the weight of said resin;
obtaining said core by hardening said synthetic material; and
vulcanizing at said covering of elastomer material on said core of synthetic material.

2. A method of fabricating a composite insulator according to claim 1, characterized in that the covering is molded around the core.

3. A method of fabricating a composite insulator according to claim 2, characterized in that it further comprises fastening metal end fittings to the ends of said core and molding the covering around said core and said end fittings.

4. A method of fabricating a composite insulator according to claim 2, characterized in that the covering is formed by an injection molding method.

5. A method of fabricating a composite insulator according to claim 2, characterized in that the covering is formed by a compression molding method.

6. A method of fabricating a composite insulator according to claim 2, characterized in that the covering is formed by an extrusion method.

7. (canceled)

8. (canceled)

9. A method of fabricating a composite insulator according to claim 2, characterized in that said glass transition temperature of said synthetic material lies in the range 130° C. to 220° C., preferably in the range 170° C. to 190° C.

10. (canceled)

11. (canceled)

12. (canceled)

13. A method of fabricating a composite insulator according to claim 2, characterized in that in order to reinforce said synthetic material, glass fibers are used having a diameter lying in the range 10 μm to 40 μm.

14. A composite insulator obtained by a fabrication method according to claim 2, the insulator being characterized in that it includes a tube type hollow core.

15. A composite insulator obtained by a fabrication method according to claim 2, characterized in that it includes a rod type solid core.

16. A method of fabricating a composite insulator according to claim 1, characterized in that it further comprises fastening metal end fittings to the ends of said core and molding the covering around said core and said end fittings.

17. A method of fabricating a composite insulator according to claim 1, characterized in that the covering is formed by an injection molding method.

18. A method of fabricating a composite insulator according to claim 1, characterized in that the covering is formed by a compression molding method.

19. A method of fabricating a composite insulator according to claim 1, characterized in that the covering is formed by an extrusion method.

20. A method of fabricating a composite insulator according to claim 1, characterized in that said glass transition temperature of said synthetic material lies in the range 130° C. to 220° C., preferably in the range 170° C. to 190° C.

21. A method of fabricating a composite insulator according to claim 1, characterized in that in order to reinforce said synthetic material, glass fibers are used having a diameter lying in the range 10 μm to 40 μm.

22. A composite insulator obtained by a fabrication method according to claim 1, the insulator being characterized in that it includes a tube type hollow core.

23. A composite insulator obtained by a fabrication method according to claim 1, characterized in that it includes a rod type solid core.
